(19) United States
(12) Patent Application Publication
(10) Pub. No.: US 2022/0328857 A1
(43) Pub. Date: Oct. 13, 2022

(54) WELDED FLOWING ELECTROLYTE BATTERY CELL STACK

(71) Applicant: RedFlow R&D Pty Ltd, Seventeen Mile Rocks (AU)

(72) Inventors: Alexander Rudolf Winter, Seventeen Mile Rocks (AU); Thomas John, Seventeen Mile Rocks, Queensland (AU)

(73) Assignee: RedFlow R&D Pty Ltd, Seventeen Mile Rocks (AU)

(21) Appl. No.: 17/754,456

(22) PCT Filed: Sep. 29, 2020
(86) PCT No.: PCT/AU2020/051036

§ 371 Date: Apr. 1, 2022

(30) Foreign Application Priority Data
Oct. 4, 2019 (AU) 2019903742

(51) Int. Cl. H01M 8/2404; H01M 8/248

(52) U.S. Cl. CPC H01M 8/2404; H01M 8/248

(57) ABSTRACT

A system and method for a flowing electrolyte battery enables compression plates to be produced from a uni-directional glass fibre reinforced thermoplastic composite. The system includes: a cell stack of electrodes and separators, with a compression plate consisting of thermoplastic composite with uni-directional glass fibre reinforcement layers, with at least one layer of the uni-directional glass fibre configured in a direction perpendicular to a direction of another layer of uni-directional glass fibre; at least one integral manifold adjacent to the cell stack configured to seal the cell stack; and side plates consisting of thermoplastic composite with a plurality of uni-directional glass fibre layers configured in a direction perpendicular to the compression plates, the side plates consisting of at least one surface layer of a first end layer or a second end layer of thermoplastic composite having less uni-directional glass fibre content than another layer.

### CROSS-REFERENCE TO RELATED APPLICATIONS

This application is the U.S. national stage of PCT/AU2020/051036, filed on Sep. 29, 2020, which claims priority of Australian Provisional Patent Application No. 2019903742, filed on Oct. 4, 2019. The disclosures of these prior applications are considered part of the disclosure of this application and are hereby incorporated by reference in their entireties.

### TECHNICAL FIELD

The present disclosure relates to flowing electrolyte batteries. In particular, although not exclusively, the disclosure relates to a method and system of forming side plates and compression plates for a cell stack system of a flowing electrolyte battery.

### BACKGROUND

Batteries used in stand alone power supply systems are commonly lead-acid batteries. However, lead-acid batteries have limitations in terms of performance and environmental safety. Typical lead-acid batteries often have very short lifetimes in hot climate conditions, especially when they are occasionally fully discharged. Lead-acid batteries are also environmentally hazardous, since lead is a major component of lead-acid batteries and can cause serious environmental problems during manufacturing and disposal.

Flowing electrolyte batteries, such as zinc-bromine batteries, zinc-chlorine batteries, and vanadium flow batteries, offer a potential to overcome the above mentioned limitations of lead-acid batteries. In particular, the useful lifetime of flowing electrolyte batteries is not affected by deep discharge applications, and the energy to weight ratio of flowing electrolyte batteries is up to six times higher than that of lead-acid batteries.

However, manufacturing flowing electrolyte batteries can be more difficult than manufacturing lead-acid batteries. A flowing electrolyte battery, like a lead acid battery, comprises a stack of cells to produce a certain voltage higher than that of individual cells. But unlike a lead acid battery, cells in a flowing electrolyte battery are hydraulically connected through an electrolyte circulation path. This can be problematic as shunt currents can flow through the electrolyte circulation path from one series-connected cell to another causing energy losses and imbalances in the individual charge states of the cells. To prevent or reduce such shunt currents, flowing electrolyte batteries define sufficiently long electrolyte circulation paths between cells, thereby increasing electrical resistance between cells.

Assembly of a typical cell stack often involves gluing or welding of gaskets or o-ring seals to contain the electrolyte circulation. A hydraulic seal generally must be provided between cells and between the inside and outside of the battery cell stack system, ensuring the containment of electrolyte and also maintaining equal distribution of electrolyte on the electrode surfaces.

For a typical 60-cell stack, there may be up to 121 seals between electrodes and separator plates, each measuring upward of 1.5 m in length. This results in a total of 181 m of critical sealing length, where even the slightest leak may lead to the entire stack failing.

Systems involving o-ring seals introduce difficulties in maintaining geometry of the plastic or elastomer seal, with deformation and creep deflection often becoming an issue over time. Consequently, constant force needs to be applied through spring loaded devices and/or the re-torqueing of compression bolts holding the cell stack together. The metallic components involved with these types of compression plates are also vulnerable to corrosion over time. This translates to expensive upfront costs of hardware and also the requirement of ongoing maintenance.

Other manufacturing methods of sealing cell stacks may involve vibration or ultrasonic welded seals. However, these may require upwards of 60 seconds for each plate to be formed and welded sequentially, leading to very long build times for each cell stack.

Further, the methods involved in producing cell stacks involve high amounts of manual labour. Workers may need to assemble the cell stack plate by plate, inserting and positioning the seals or gaskets, or making multiple individual welds. There is therefore a need to overcome or alleviate many of the above discussed problems associated with flowing electrolyte batteries of the prior art.

### Object of the Disclosure

It is a preferred object of the present disclosure to provide methods and/or systems that address or ameliorate one or more limitations of the aforementioned problems of the prior art and/or provide a useful commercial alternative.

### SUMMARY

The present disclosure relates to methods and/or systems in which a cell stack system for a flowing electrolyte battery can be formed.

In one form, although not necessarily the broadest form, the disclosure resides in a method of forming a cell stack system for a flowing electrolyte battery, the method comprising: forming a cell stack by stacking in a mould a plurality of electrodes and separators; attaching a compression plate to each of a first end and a second end of the cell stack, wherein the compression plates are made from a thermoplastic composite reinforced with uni-directional glass fibre, the uni-directional glass fibre applied in a plurality of layers, with at least one layer of the uni-directional glass fibre applied in a direction different from a direction of another of layer of uni-directional glass fibre, applying pressure to the cell stack to compress the cell stack to a predetermined height, defining at least one manifold adjacent to the cell stack, and welding side plates to the cell stack, wherein the side plates are made from a thermoplastic composite reinforced with uni-directional glass fibre, the uni-directional glass fibre applied in a plurality of layers in a direction perpendicular to the compression plates, with at least one surface layer of a first end layer or a second end layer of thermoplastic composite having less uni-directional glass fibre content than another layer.

Preferably, the welding faces of the side plates and the sides of the cell stack are pre-heated and then brought together to form a weld.

Preferably, the welding of the side plates is done in pairs.

Preferably, the welding of the side plates is done simultaneously.

Preferably, two sides of the plates are welded on first, any overhanging ends are trimmed off, and two or more remaining sides plates are then welded on.

Preferably, the side plates approach the cell stack at an angle and are progressively welded on to the cell stack.

Preferably, a roller is used to press the side plates onto the cell stack when welding.

Preferably, the thermoplastic composite of the compression plates is made from a high-density polyethylene, and the plurality of layers of thermoplastic composite reinforced with uni-directional glass fibre of the compression plates is formed of three layer-groups with perpendicularly alternating uni-directional glass fibre directions.

Preferably, the compression plates are formed by pressing together the plurality of layers of thermoplastic composite reinforced with uni-directional glass fibre at a temperature of about 150° C. to 200° C. for a period of about 3 to 12 minutes.

Preferably, the thermoplastic composite of the side plates is high-density polyethylene.

Further preferably, the at least one surface layer of a first end layer or a second end layer of thermoplastic composite is without uni-directional glass fibre.

Preferably, the manifold is an integral manifold that is injection moulded adjacent to the cell stack and seals the cell stack.

Preferably, the at least one layer of the uni-directional glass fibre applied in the direction different from the direction of another layer of uni-directional glass fibre is applied generally perpendicular to the direction of another layer of uni-directional glass fibre.

According to another form, the disclosure resides in a system for a flowing electrolyte battery, the system comprising: a cell stack of electrodes and separators, with a compression plate at each end of the cell stack, the compression plates consisting of thermoplastic composite with uni-directional glass fibre reinforcement layers, with at least one layer of the uni-directional glass fibre configured in a direction perpendicular to a direction of another layer of uni-directional glass fibre, at least one integral manifold adjacent to the cell stack configured to seal the cell stack, and side plates consisting of thermoplastic composite with a plurality of uni-directional glass fibre layers configured in a direction perpendicular to the compression plates, the side plates consisting of at least one surface layer of a first end layer or a second end layer of thermoplastic composite having less uni-directional glass fibre content than another layer.

Preferably, the thermoplastic composite of the compression plates is a high-density polyethylene, and the plurality of uni-directional glass fibre layers of the compression plates is configured into three layer-groups with perpendicularly alternating uni-directional glass fibre directions.

Preferably, the thermoplastic composite of the side plates is high-density polyethylene.

Preferably, the at least one surface layer of a first end layer or a second end layer of thermoplastic composite is without glass fibre.

Preferably, the system further comprises one or more collector plates, wherein the one or more collector plates are integrated into one part with at least one of the compression plates.

### BRIEF DESCRIPTION OF THE DRAWINGS

To assist in understanding the disclosure and to enable a person skilled in the art to put the disclosure into practical effect, preferred embodiments of the disclosure are described below by way of example only with reference to the accompanying drawings, in which:

FIG. 1 is a diagrammatic perspective view of a formed flowing electrolyte battery cell stack system, according to an embodiment of the present disclosure.

FIG. 2 is an exploded view illustrating the cell stack system of FIG. 1, showing the cell stack with exploded side plates.

FIG. 3 is an exploded view illustrating the compression plates of FIG. 2 with exploded layers.

FIG. 4 is an exploded view illustrating the side plates of FIG. 2 with exploded layers.

FIG. 5 is a cut-away view illustrating assembly of the flowing electrolyte battery cell stack system of FIG. 1 and application of the side plates.

### DETAILED DESCRIPTION OF THE DISCLOSURE

The present disclosure relates to methods and/or systems in which a cell stack system for a flowing electrolyte battery can be formed. Elements of the disclosure are illustrated in concise outline form in the drawings, showing only those specific details that are necessary to understanding the embodiments of the present disclosure, but so as not to clutter the disclosure with excessive detail that will be obvious to those of ordinary skill in the art in light of the present description.

According to one aspect, the disclosure is defined as a method of forming a cell stack system for a flowing electrolyte battery, the method comprising: forming a cell stack by stacking in a mould a plurality of electrodes and separators; attaching a compression plate to each of a first end and a second end of the cell stack, wherein the compression plates are made from a thermoplastic composite reinforced with uni-directional glass fibre, the uni-directional glass fibre applied in a plurality of layers, with at least one layer of the uni-directional glass fibre applied in a direction different from a direction of another of layer of uni-directional glass fibre, applying pressure to the cell stack to compress the cell stack to a predetermined height, defining at least one manifold adjacent to the cell stack, and welding side plates to the cell stack, wherein the side plates are made from a thermoplastic composite reinforced with uni-directional glass fibre, the uni-directional glass fibre applied in a plurality of layers in a direction perpendicular to the compression plates, with at least one surface layer of a first end layer or a second end layer of thermoplastic composite having less uni-directional glass fibre content than another layer.

Advantages of some embodiments of the present disclosure include a method of forming a cell stack system for a flowing electrolyte battery which enables compression plates to be produced from a uni-directional glass fibre reinforced thermoplastic composite which is able to maintain stiffness and is resistant to creep.

Further, according to some embodiments the battery cell stack side plates are also reinforced with uni-directional glass fibre to be sufficiently stiff and resistant to creep, so that problems surrounding separation of electrodes over time are also mitigated. With welded side plates, each electrode and each separator has an individual and direct weld, resulting in a locked geometry instead of the compression maintained geometry of gasket type designs which rely on spring loaded compression bolts and metal compression plates. With the welding surface of the side plates being non-glass filled or with a low glass fibre content, the weld is provided with more resin to ensure a hermetic seal with the compression plates and each electrode and each separator. Metal compression plates and associated hardware are therefore not needed to secure the plates in place and/or maintain geometry and integrity, mitigating the issues of component corrosion.

Those skilled in the art will appreciate that not all of the above advantages are necessarily included in all embodiments of the present disclosure.

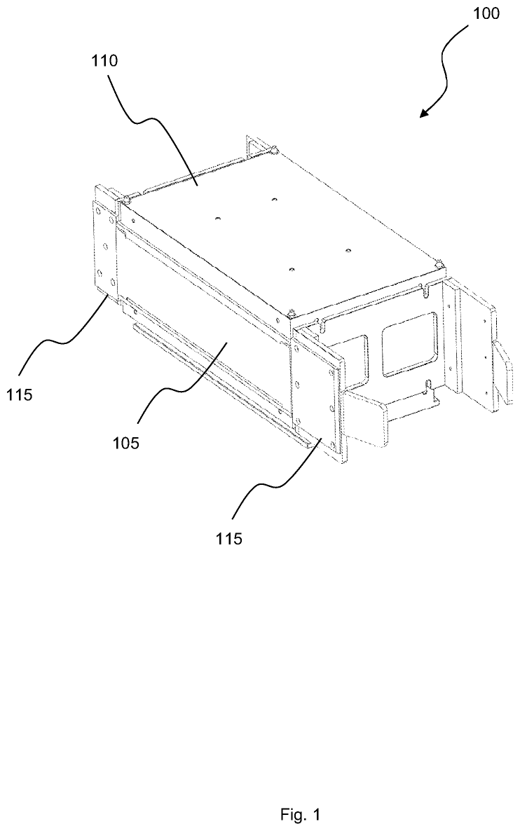

FIG. 1 is a diagrammatic perspective view of a formed flowing electrolyte battery cell stack system 100, according to an embodiment of the present disclosure. Shown in a compressed position, the battery cell stack system 100 is held in place by clamp plates 110 which compress the cell stack 105 and secures the cell stack system 100 together in preparation for welding of the plates on the long sides. Support plates with thermal insulation 115 are installed so the side welding can begin before the cell stack and finish after the cell stack. This allows the use of a continuous length of side plate to be welded to more than one stack sequentially in a manufacturing environment. It also allows the heating and melting of the side plate to stabilize before beginning the bonding with the cells.

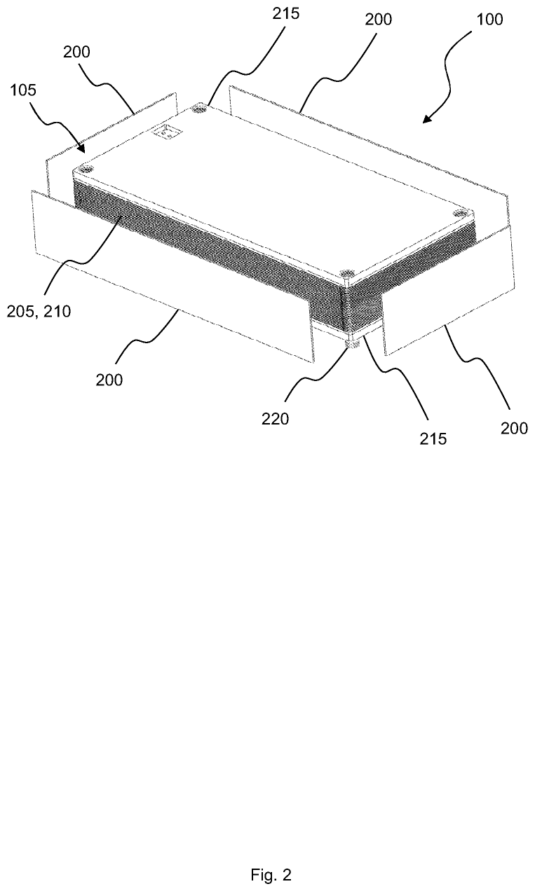

FIG. 2 is an exploded view illustrating the battery cell stack system 100, and showing a cell stack 105 with exploded side plates 200. The cell stack 105 is shown with a plurality of electrodes 205 and separators 210, with a compression plate 215 on each of a first (top) end and a second (bottom) end of the cell stack 105. Also shown in FIG. 2 are integral manifolds 220 which have been injection moulded after the cell stack 105 has been clamped down by clamping plates 110. The integral manifolds 220 allow, for example, capillary tubes (not shown) of the electrodes 205 and separators 210 to be connected, and also seals the layers together. Alternatively, capillary channels can be formed with a welded foil and provide the same functionality as capillary tubes. Further, the compression plate can be integrated with a collector to form a unidirectional glass fibre reinforced collector plate that needs no separate end compression plate.

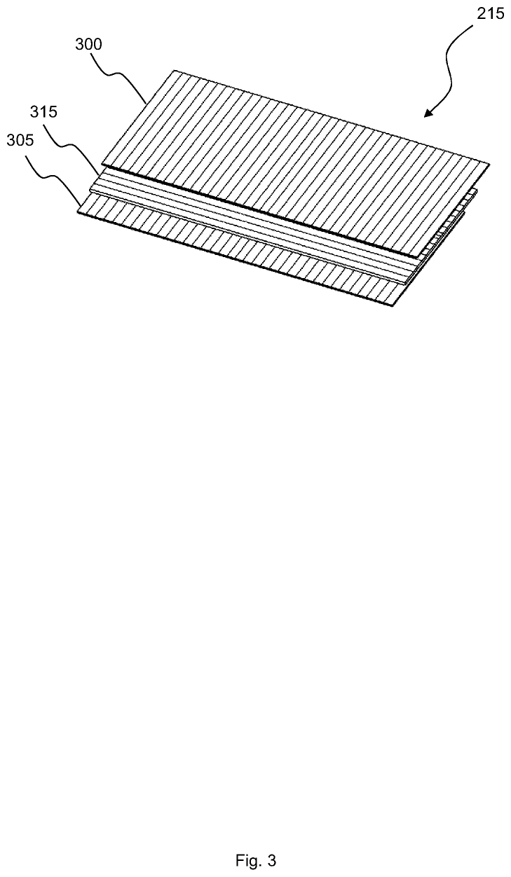

FIG. 3 is an exploded view illustrating the compression plates 215. The compression plates 215 are made from a thermoplastic composite reinforced with uni-directional glass fibre, applied in a plurality of layers. These layers may be grouped into different orientations and directions of the uni-direction glass fibre reinforcement. In a preferred embodiment, at least one layer or a layer group 300, 305, 315 of the uni-directional glass fibre is applied in a direction perpendicular to a direction of another of layer of uni-directional glass fibre.

As shown, the layers 300, 305, 315 are grouped into three groups, wherein a top layer group 300 and a bottom layer group 305 contain uni-directional glass fibre reinforcement running in the same direction, while a middle layer group 310 contains uni-directional glass fibre reinforcement running in a direction perpendicular to the uni-directional glass fibre reinforcement direction of the top layer group 300 and the bottom layer group 305.

Optionally, the number of layers in the middle layer group 310 equals the combined number of layers in the top layer group 300 and the bottom layer group 305. Further optionally, the top layer group 300 and the bottom layer group 305 each consists of 14 layers of uni-directional glass fibre reinforced thermoplastic composite sheet, and the middle layer group 310 consists of 28 layers of uni-directional glass fibre reinforced thermoplastic composite sheet.

In a preferred embodiment, the thermoplastic composite of the compression plates 215 is high-density polyethylene. Preferably, the compression plates 215 are formed by cold assembly of glass fibre tape aligned in the appropriate directions. The assembly is then heat bonded to form a plate by pressing the plurality of layer groups 300, 305, 310 together at a temperature of 120° C. to 180° C. for 5 to 8 minutes. Further preferably, the compression plates 215 are formed by pressing the plurality of layer groups 300, 305, 310 together at a temperature of 170° C. for 7 minutes. Skilled addressees will understand that the specific temperature and time may depend upon variables such as desired thickness and/or material selection.

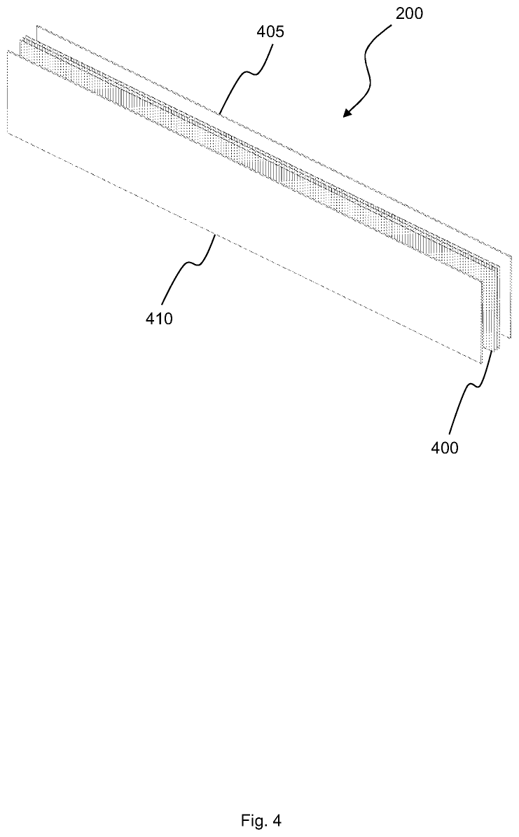

FIG. 4 is an exploded view illustrating a composition of the side plates 200 of the cell stack system 100. The side plates 200 are made from a thermoplastic composite reinforced with uni-directional glass fibre, the uni-directional glass fibre applied in a plurality of layers 400 in a direction perpendicular to a length of the compression plates 215, wherein at least one surface layer of a first end layer 405 and/or a second end layer 410 of thermoplastic composite does not include, or includes only a low amount of, uni-directional glass fibre. Preferably, the side plates 200 are formed in a similar way to the compression plates, by cold assembly of glass fibre tape and subsequent heat bonding.

While uni-directional glass fibres are bonded to the resin after heat bonding, there may remain fine air passages between fibres due to incomplete wetting. These microscopic air passages can allow liquid to travel along them and result in weeping leaks. However, according to the present disclosure, the at least one surface layer of a first end layer 405 and/or a second end layer 410 of thermoplastic composite which does not include, or includes only a low amount of, uni-directional glass fibre provides a hermetic seal and prevents liquid escaping along the air passages, ameliorating the aforementioned problems.

In a preferred embodiment, the uni-directional glass fibre reinforcing the side plates 200 are oriented in a direction perpendicular to the compression plates 215. This allows for sufficient stiffness in the side plates 200 in the direction perpendicular to the compression plates 215, so that shear load generated by internal stack pressures may be distributed uniformly across the weld between the side plates 200 and the compression plates 215. Standard thermoplastic composites filled with chopped or milled fibres would not provide enough stiffness in the side plates 200, causing weld failure from stress. While thermoplastic composites filled with chopped or milled fibres could produce compression plates in conjunction with side plates containing uni-directional glass fibre reinforcement, an extremely thick compression plate would be required in order to maintain flatness and resist creep deflection. However, according to the present disclosure, side plates 200 with uni-directional glass fibre reinforcement in a direction perpendicular to the uni-directional glass fibre reinforced compression plates 215 provide sufficient stiffness and ameliorates the aforementioned problems.

In a further embodiment, the side plates 200 comprise multiple layers of thermoplastic composite, wherein at least one of a first end layer 405 or a second end layer 410 is without, or contains only a small amount of, glass fibre. That enables the weld between the side plates 200 and the cell stack 105 to be provided with more resin to ensure a hermetic seal.

Optionally, the side plates 200 comprise a first end layer 405 and a second end layer 410 of thermoplastic composite without, or only containing a small amount of, glass fibre reinforcement, while three layers of uni-directional glass fibre reinforced thermoplastic composite layers 400 are sandwiched in between the first end layer 405 and the second end layer 410. Further optionally, the thermoplastic composite of the side plates 200 is high-density polyethylene. Skilled addressees will understand that the specific number of layers and glass fibre content of the end layers 405, 410 may vary according to need and design.

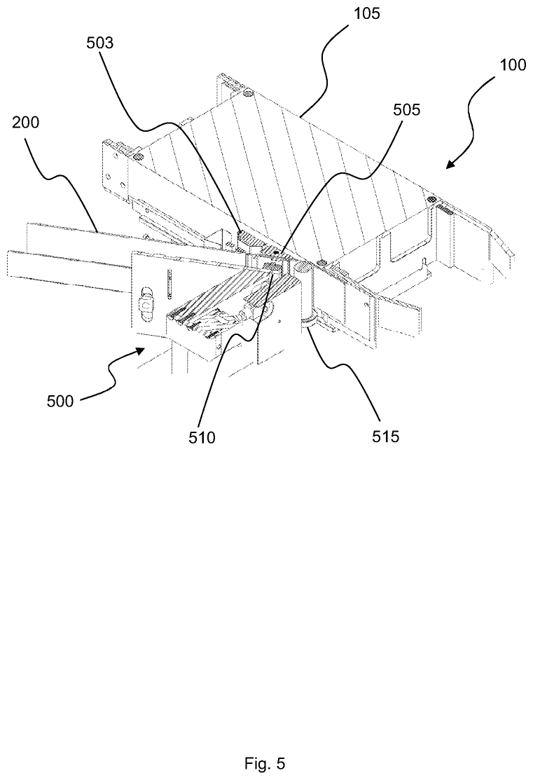

FIG. 5 is a cut-away view illustrating assembly of the flowing electrolyte battery cell stack system 100 and application of a side plate 200. In a preferred embodiment, the welding faces of the side plate 200 and the sides of the cell stack 105 are pre-heated before being brought together to form a weld. Preferably, the welding face of the cell stack 105 is pre-heated by an assembly jig 500 including a non-contact ceramic heater 503, while the side plate 200 is heated by a wedge-shaped heater 505 pressed against the side plate 200 by a pneumatic actuator 510. Further preferably, the wedge-shaped heater 505 causes an end layer of the side plate 200 to reach and maintain welding temperature while softening the side plate 200 enough to be flexible.

As shown, a preheated side plate 200 is configured to approach the cell stack 105 at an angle of 25° to 35°, and a roller 515 of the assembly jig 500 then presses the side plate 200 onto the pre-heated face of the cell stack 105, welding the side plate 200 in place. By using a roller 515, the preheated surface of the side plate 200 is applied against the preheated cell stack 105 with high local pressure, but not high total force. As the side plate 200 moves along the roller 515, the side plate 200 is bonded to the side of the cell stack 105 without any air being trapped in the weld.

Optionally, welding of the side plates 200 is done in pairs, with heaters 503, 505 and rollers 515 on both sides, applying the welds concurrently. Further optionally, two sides of the cell stack 105 may be welded with side plates 200 first, and then overhanging ends are trimmed off before welding side plates 200 to the remaining sides. Further optionally, all sides of the cell stack 105 may have side plates 200 welded and applied simultaneously. Skilled addressees will understand that the specific sequence of welding side plates 200 may vary according to design requirements.

The battery cell stack system 100 therefore addresses at least some of the aforementioned problems, providing thermoplastic side plates 200 and compression plates 215 formed through heat welding, while maintaining the stiffness required to maintain integrity through the life of the battery cell stack system 100. While there are typically high cyclic stress loads associated with operation of the cell stack 105 due to electrolyte pressure fluctuations, the uni-directional glass fibre reinforced thermoplastic compression plates 215 and side plates 200 provide a useful alternative when applied with the welding methods described above. The high stiffness and strength of the side plates help to uniformly distribute shear forces, with the perpendicular uni-directional glass fibre reinforcement providing good mechanical strength to resist fatigue over the life of the battery cell stack system 100. Embodiments of the present disclosure therefore can ameliorate at least the problems encountered with typical metal spring loaded compression plates and gasket systems in the production of a cell stack system for a flowing electrolyte battery.

The above description of various embodiments of the present disclosure is provided for purposes of description to one of ordinary skill in the related art. It is not intended to be exhaustive or to limit the disclosure to a single disclosed embodiment. As mentioned above, numerous alternatives and variations to the present disclosure will be apparent to those skilled in the art of the above teaching. Accordingly, while some alternative embodiments have been discussed specifically, other embodiments will be apparent or relatively easily developed by those of ordinary skill in the art. This patent specification is intended to embrace all alternatives, modifications and variations of the present disclosure that have been discussed herein, and other embodiments that fall within the spirit and scope of the above described disclosure.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present disclosure.

1. A method of forming a cell stack system for a flowing electrolyte battery, the method comprising:
forming a cell stack by stacking in a mould a plurality of electrodes and separators;
attaching a compression plate to each of a first end and a second end of the cell stack, wherein
the compression plates are made from a thermoplastic composite reinforced with uni-directional glass fibre, the uni-directional glass fibre applied in a plurality of layers, with at least one layer of the uni-directional glass fibre applied in a direction different from a direction of another layer of uni-directional glass fibre;
applying pressure to the cell stack to compress the cell stack to a predetermined height;
defining at least one manifold adjacent to the cell; and
welding side plates to the cell stack, wherein
the side plates are made from a thermoplastic composite reinforced with uni-directional glass fibre, the uni-directional glass fibre applied in a plurality of layers in a direction perpendicular to the compression plates, with at least one surface layer of a first end layer or a second end layer of thermoplastic composite having less uni-directional glass fibre content than another layer.

2. The method of claim 1, wherein the welding faces of the side plates and the sides of the cell stack are pre-heated and then brought together to form a weld.

3. The method of claim 1, wherein the welding of the side plates is done in pairs.

4. The method of claim 1, wherein the welding of the side plates is done simultaneously.

5. The method of claim 1, wherein two sides of the plates are welded on first, any overhanging ends are trimmed off, and two or more remaining sides plates are then welded on.

6. The method of claim 1, wherein the side plates approach the cell stack at an angle and are progressively welded on to the cell stack.

7. The method of claim 1, wherein a roller is used to press the side plates onto the cell stack when welding.

8. The method of claim 1, wherein the thermoplastic composite of the compression plates is made from a high-density polyethylene, and the plurality of layers of the thermoplastic composite reinforced with uni-directional glass fibre of the compression plates is formed of three layer-groups with perpendicularly alternating uni-directional glass fibre directions.

9. The method of claim 1, wherein the compression plates are formed by pressing together the plurality of layers of the thermoplastic composite reinforced with uni-directional glass fibre at a temperature of 150° C. to 250° C. for 3 to 12 minutes.

10. The method of claim 1, wherein the thermoplastic composite of the side plates is high-density polyethylene.

11. The method of claim 1, wherein the at least one surface layer of a first end layer or a second end layer of thermoplastic composite is without glass fibre.

12. The method of claim 1, wherein the manifold is an integral manifold that is injection moulded adjacent to the cell stack and seals the cell stack.

13. The method of claim 1, wherein the at least one layer of the uni-directional glass fibre applied in the direction different from the direction of another layer of uni-directional glass fibre is applied generally perpendicular to the direction of another layer of uni-directional glass fibre.

14. A system for a flowing electrolyte battery, the system comprising:
a cell stack of electrodes and separators, with a compression plate at each end of the cell stack,
the compression plates consisting of thermoplastic composite with uni-directional glass fibre reinforcement layers, with at least one layer of the uni-directional glass fibre configured in a direction perpendicular to a direction of another layer of uni-directional glass fibre,
at least one integral manifold adjacent to the cell stack configured to seal the cell stack, and
side plates consisting of thermoplastic composite with a plurality of uni-directional glass fibre layers configured in a direction perpendicular to the compression plates, the side plates consisting of at least one surface layer of a first end layer or a second end layer of thermoplastic composite having less uni-directional glass fibre content than another layer.

15. The system of claim 14, wherein the thermoplastic composite of the compression plates is a high-density polyethylene, and
wherein the plurality of uni-directional glass fibre layers of the compression plates is configured into three layer-groups with perpendicularly alternating uni-directional glass fibre directions.

16. The system of claim 14, wherein the thermoplastic composite of the side plates is high-density polyethylene.

17. The system of claim 14, wherein the at least one surface layer of a first end layer or a second end layer of thermoplastic composite is without glass fibre.

18. The system of claim 14, further comprising one or more collector plates, wherein the one or more collector plates are integrated into one part with at least one of the compression plates.
